(19) United States
(12) Patent Application Publication
(10) Pub. No.: US 2024/0265781 A1
(43) Pub. Date: Aug. 8, 2024

(54) SERVICE PROVIDING SERVER THAT PROVIDES A TOURNAMENT GAME SERVICE THAT SUPPORTS PARTICIPATION IN A GAME TOURNAMENT THROUGH THE SETTING OF AN NFT-BASED USER PROFILE AND THE OPERATING METHOD THEREOF

(71) Applicant: Supertree Co., Ltd., Seoul (KR)

(72) Inventor: Sung Wone CHOI, Seoul (KR)

(73) Assignee: Supertree Co., Ltd., Seoul (KR)

(21) Appl. No.: 18/423,323

(22) Filed: Jan. 26, 2024

(30) Foreign Application Priority Data
Feb. 7, 2023 (KR) 10-2023-0015933

(51) Int. Cl. G07F 17/32

(52) U.S. Cl. CPC G07F 17/3276; G07F 17/3239

(57) ABSTRACT

Disclosed are a service providing server that provides a tournament game service that supports participation in a game tournament through the setting of a non-fungible token (NFT)-based user profile and the operating method thereof to support users to enjoy a game while competing by a tournament scheme jointly with other users in an online environment.

### CROSS-REFERENCE TO RELATED APPLICATIONS

This application claims priority to and the benefit of Korean Patent Application No. 10-2023-0015933 filed in the Korean Intellectual Property Office on Feb. 7, 2023, the entire contents of which are incorporated herein by reference.

### TECHNICAL FIELD

The present disclosure relates to a service providing server that provides a tournament game service that supports participation in a game tournament through the setting of a non-fungible token (NFT)-based user profile and the operating method thereof.

### BACKGROUND ART

Recently, as various electronic terminals including desktop PCs, smart phones, tablet PCs, console game machines, etc., have been released, the number of persons who play games through the electronic terminals has increased.

In particular, the recent electronic terminals provide an environment which enables playing games with other persons through online, in that the electronic terminals enable online connections.

As such, as the environment to play the games with other persons online has widely spread, an interest in the introduction of a new business model using online-based games is also increasing.

Normally, the online-based games are designed to allow persons to compete with each other in an online environment, so it is possible to consider introduction of a predetermined tournament service using the online-based games.

For example, by holding a tournament competition using a number of games so that persons participate in the tournament of the game they want, the introduction of a business model that pays a certain reward to the winner who wins a specific tournament competition can be considered.

However, in order to provide a tournament platform service using these games, user management technology needs to be introduced, which allows anybody not to participate in the tournament, but allows only the users who qualify for participating in a predetermined tournament to participate in the tournament to improve the quality of the service.

In this regard, the introduction of service technology can be considered, which allows only predetermined certified members to participate in the tournament, and at the same time, issues a predetermined ticket for participating in the tournament, and allows only the persons who purchase this ticket to participate in the tournament of a specific game.

In addition, as the use of an NFT has increased recently, it is possible to use the method of issuing and managing a profile of a user who participates in the tournament as the NFT. Here, the non-fungible token (NFT) which means a ‘non-fungible token’ means a virtual asset that is impossible to replace each token with another token because a unique value is given to each token, and the NFT has an advantage of ensuring excellent reliability, and easily proving uniqueness and ownership of contents. Specifically, profile information of each user, which includes tournament participation history information of a user who participates in a tournament, level information calculated based on a tournament participation record, reward reception history information according to tournament participation, and information on the quantity of holding tickets for the tournament participation is included in an NFT and managed through a blockchain to support the user to own his/her own profile according to game tournament participation in the form of a predetermined virtual asset.

In that when the profile management through the NFT is performed, the information on the quantity of holding tickets to participate in the tournament can be included in the NFT of each user and managed through the blockchain, more reliable verification of a quantification of a user who intends to participate in the tournament may also be enabled.

### SUMMARY OF THE INVENTION

The present disclosure has been made in an effort to provide a service providing server that provides a tournament game service that supports participation in a game tournament through the setting of a non-fungible token (NFT)-based user profile and the operating method thereof to support users to enjoy a game while competing by a tournament scheme jointly with other users in an online environment.

An exemplary embodiment of the present disclosure provides a service providing server that provides a tournament game service that supports participation in a game tournament through the setting of a non-fungible token (NFT)-based user profile, which includes: a game information storage unit storing information on the number of required tickets for participating in tournaments of a plurality of predetermined respective games; a price information storage unit storing purchase price information of the ticket for participating in the tournament; a profile generation unit generating, when a new user registration request command for using the tournament game service is received from a first electronic terminal of a first user, a first profile table for recording tournament participation history information of the first user, level information calculated based on a tournament participation record, reward reception history information according to tournament participation, and information on the quantity of holding tickets for the tournament participation; an NFT generation unit requesting the first electronic terminal to transmit identification information for identifying the first user, and when first user identification information is received from the first electronic terminal, generating a first NFT which includes the first profile table, and at the same time, includes the first user identification information as owner information; a registration processing unit registering and processing, when the first NFT is generated, the first NFT in a predetermined blockchain network for registering the NFT, and completing issuing the first NFT to complete new user registration; a completion message transmission unit generating, when issuance of the first NFT is completed, a registration completion message indicating that issuance of the first NFT is completed and at the same time, indicating that the new user registration is completed, and transmitting the registration completion message to the first electronic terminal; a payment processing unit requesting, upon receiving the purchase request command of requesting purchasing tickets as large as a first purchase quantity from the first electronic terminal after the issuance of the first NFT is completed, transmission of payment means information to the first electronic terminal, and calculating, upon receiving first payment means information from the first electronic terminal, a price corresponding to the first purchase quantity based on the purchase price information, and then performing payment processing for the calculated price based on the first payment means information; and a profile update unit generating, when the payment processing is completed, a first transaction indicting that the first user possesses tickets of the first purchase quantity, and registering and processing the first transaction in the blockchain network to process the quantity of holding tickets in the first profile table included in the first NFT registered in the blockchain network to be increased by the first purchase quantity, and recorded.

Further, another exemplary embodiment of the present disclosure provides an operating method of a service providing server that provides a tournament game service that supports participation in a game tournament through the setting of a non-fungible token (NFT)-based user profile, which includes: maintaining a game information storage unit storing information on the number of required tickets for participating in tournaments of a plurality of predetermined respective games; maintaining a price information storage unit storing purchase price information of the ticket for participating in the tournament; generating, when a new user registration request command for using the tournament game service is received from a first electronic terminal of a first user, a first profile table for recording tournament participation history information of the first user, level information calculated based on a tournament participation record, reward reception history information according to tournament participation, and information on the quantity of holding tickets for the tournament participation; requesting the first electronic terminal to transmit identification information for identifying the first user, and when first user identification information is received from the first electronic terminal, generating a first NFT which includes the first profile table, and at the same time, includes the first user identification information as owner information; registering and processing, when the first NFT is generated, the first NFT in a predetermined blockchain network for registering the NFT, and completing issuing the first NFT to complete new user registration; generating, when issuance of the first NFT is completed, a registration completion message indicating that issuance of the first NFT is completed and at the same time, indicating that the new user registration is completed, and transmitting the registration completion message to the first electronic terminal; requesting, upon receiving the purchase request command of requesting purchasing tickets as large as a first purchase quantity from the first electronic terminal after the issuance of the first NFT is completed, transmission of payment means information to the first electronic terminal, and calculating, upon receiving first payment means information from the first electronic terminal, a price corresponding to the first purchase quantity based on the purchase price information, and then performing payment processing for the calculated price based on the first payment means information; and generating, when the payment processing is completed, a first transaction indicting that the first user possesses tickets of the first purchase quantity, and registering and processing the first transaction in the blockchain network to process the quantity of holding tickets in the first profile table included in the first NFT registered in the blockchain network to be increased by the first purchase quantity, and recorded.

According to exemplary embodiments of the present disclosure, a service providing server that provides a tournament game service that supports participation in a game tournament through the setting of a non-fungible token (NFT)-based user profile and the operating method thereof are provided to support users to enjoy a game while competing by a tournament scheme jointly with other users in an online environment.

### BRIEF DESCRIPTION OF THE DRAWINGS

FIG. 1 is a diagram illustrating a structure of a service providing server according to an exemplary embodiment of the present disclosure.

FIG. 2 is a diagram for describing an operation of a service providing server according to an exemplary embodiment of the present disclosure.

FIG. 3 is a flowchart illustrating an operating method of a service providing server according to an exemplary embodiment of the present disclosure.

### DETAILED DESCRIPTION

Hereinafter, exemplary embodiments of the present disclosure will be described in detail with reference to the accompanying drawings. The description does not limit the present disclosure to specific exemplary embodiments, and it should be understood that the present disclosure covers all the modifications, equivalents and replacements included within the idea and technical scope of the present disclosure. In describing each drawing, like reference numerals refer to like elements and if not contrarily defined, all terms used herein including technological or scientific terms have the same meanings as those generally understood by a person with ordinary skill in the art.

In this document, unless explicitly described to the contrary, the word “comprise” and variations such as “comprises” or “comprising”, will be understood to imply the inclusion of stated elements but not the exclusion of any other elements. Further, in various exemplary embodiments of the present disclosure, each of the components, functional blocks or means may be constituted by one or more lower components and electrical, electronic, and mechanical functions performed by respective components may be implemented as various known devices or mechanical elements including an electronic circuit, an integrated circuit, an Application Specific Integrated Circuit (ASIC), etc., and the respective components may be separately implemented or two or more components may be integrated into one and implemented.

Meanwhile, blocks of the accompanying block diagram or steps of a flowchart may be appreciated as meaning computer program instructions mounted on a processor or a memory of data processible equipment such as a universal computer, a special computer, a portable notebook computer, a network computer, etc., and performing designated functions. Since the computer program instructions may be stored in a memory provided in a computer device or a computer readable memory, functions described in blocks of a block diagram or steps of a flowchart may be produced as a manufactured object including an instruction mean performing the functions. Moreover, each block or each step may represent a part of a module, a segment, or a code that includes one or more executable instructions for executing a specified logical function(s). It should also be noted that in some replaceable embodiments, the functions mentioned in the blocks or steps may also be executed differently from a predetermined order. For example, two blocks or steps that are subsequently illustrated are substantially simultaneously carried out, or may be performed in a reverse order, and in some cases, the functions may be performed while some blocks or steps are omitted.

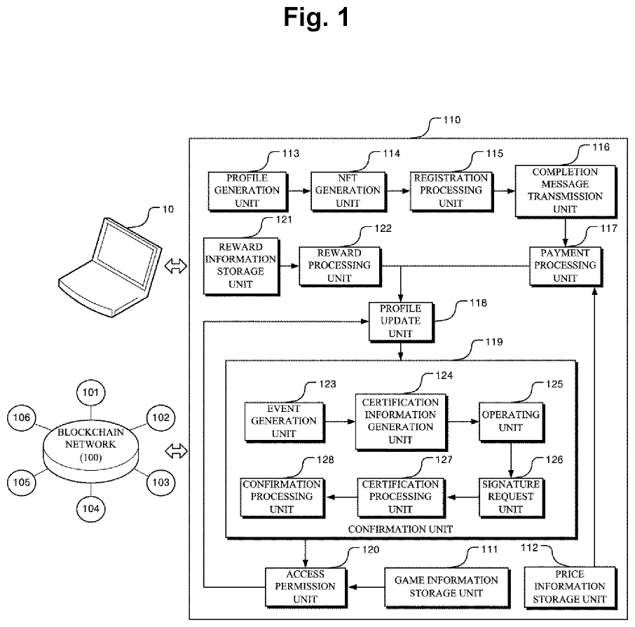

FIG. 1 is a diagram illustrating a structure of a service providing server that provides a tournament game service that supports participation in a game tournament through the setting of a non-fungible token (NFT)-based user profile according to an exemplary embodiment of the present disclosure.

Referring to FIG. 1, the service providing server 110 according to the present disclosure includes a game information storage unit 111, a price information storage unit 112, a profile generation unit 113, an NFT generation unit 114, a registration processing unit 115, a completion message transmission unit 116, a payment processing unit 117, and a profile update unit 118.

The game information storage unit 111 stores information on the number of required tickets for participating in tournaments of a plurality of predetermined respective games.

For example, the game information storage unit 111 may store information shown in Table 1 below.

TABLE 1

| Plurality of games | Number of required tickets |
|---|---|
| Game 1 | 2 |
| Game 2 | 1 |
| Game 3 | 5 |
| Game 4 | 7 |
| . . . | . . . |

The price information storage unit 112 stores purchase price information of the ticket for participating in the tournament.

For example, the price information storage unit 112 may store purchase price information of ‘5000 won per ticket’ as the purchase price information of the ticket.

When the profile generation unit 113 receives a new user registration request command for using the tournament game service from a first electronic terminal 10 of a first user, the profile generation unit 113 generates a first profile table for recording tournament participation history information of the first user, level information calculated based on a tournament participation record, reward reception history information according to tournament participation, and information on the quantity of holding tickets for the tournament participation.

In this regard, the first profile table may be configured in a form shown in Table 2 below.

TABLE 2

| Tournament | | | Information on |
|---|---|---|---|
| participation history | Level | Reward reception | quantity of |
| information | information | history information | holding tickets |
| [symbol] | [symbol] | [symbol] | [symbol] |

[symbol]

indicates data missing or illegible when filed

Here, the level information means a kind of grade or score calculated based on a predetermined level calculation criterion according to the tournament participation record of the user. For example, when the level calculation criterion is designated so that the level is increased by ‘10 when winning the game by participating in a tournament for a specific game and the level is decreased by ‘5’ when losing the game, and when ‘user 1’ participates in the game, and wins 10 games and loses 5 games, the level of ‘user 1’ may be calculated as ‘75’. In addition, the ticket means a kind of token required for the user to participate in a tournament of a specific game.

The NFT generation unit 114 requests the first electronic terminal 10 to transmit identification information for identifying the first user, and when receiving first user identification information from the first electronic terminal 10, the NFT generation unit 114 generates a first NFT which includes the first profile table, and at the same time, includes the first user identification information as owner information.

Here, the first user identification information which means unique information for identifying the first user may become information such as a user ID for using the tournament game service, a wallet address for keeping cryptocurrency pre-issued for the first user, or a cellular phone number of a user.

In this regard, when the service providing server 110 of the present disclosure receives the first user identification information ‘1SASzdfe342sdfsdadZ09dfaawer123sdaf’ which is the wallet address for keeping the cryptocurrency of the first user from the first electronic terminal 10, the NFT generation unit 114 may generate the first NFT including the first profile table, and the first user identification information ‘1SASzdfe342sdfsdadZ09dfaawer123sdaf’ as the owner information.

When the first NFT is generated, the registration processing unit 115 registers and processes the first NFT in a predetermined blockchain network 100 for registering the NFT, and completes issuing the first NFT to complete new user registration.

In this case, according to an exemplary embodiment of the present disclosure, the registration processing unit 115 may generate a transaction including the first NFT, and then propagate the transaction to the blockchain network 100 in order to register and process the first NFT in the blockchain network 100. Then, any one node of a plurality of nodes 101, 102, 103, 104, 105, and 106 constituting the blockchain network 100 may generate a block including the transaction and propagate the generated block to the plurality of nodes 101, 102, 103, 104, 105, and 106. As a result, when the block is received in the plurality of nodes 101, 102, 103, 104, 105, and 106, the plurality of nodes 101, 102, 103, 104, 105, and 106 connects the block to blockchain data by a chain based on a previous block connected to blockchain data stored in each node by the chain to share the first NFT.

As such, when issuance of the first NFT is completed by the registration processing unit 115, the completion message transmission unit 116 generates a registration completion message indicating that issuance of the first NFT is completed and at the same time, indicating that the new user registration is completed, and transmits the registration completion message to the first electronic terminal 10.

In this case, when the first electronic terminal 10 receives the registration completion message from the service providing server 110 of the present disclosure, the first electronic terminal 10 may output the registration completion message on a screen as a text. Through this, the first user may confirm that issuance of the first NFT is completed and at the same time, that new subscription of the first user in the tournament game service is completed.

As such, when issuance of the first NFT is completed, the first user may perform purchasing a ticket for participating in a tournament of a predetermined game using the first electronic terminal 10. In this regard, the first user may access the service providing server 110 of the present disclosure, and then transmit a command of requesting purchasing tickets of a purchase quantity desired thereby, by using the first electronic terminal 10. In this regard, upon receiving the purchase request command of requesting

purchasing tickets as large as a first purchase quantity from the first electronic terminal 10 to the service providing server 110 of the present disclosure, the payment processing unit 117 requests transmission of payment means information to the first electronic terminal 10, and upon receiving first payment means information from the first electronic terminal 10, the payment processing unit 116 calculates a price corresponding to the first purchase quantity based on the purchase price information stored in the price information storage unit 112, and then perform payment processing for the calculated price based on the first payment means information.

For example, when the purchase price information of the ticket is designated as ‘5000 won per ticket’, and the service providing server 110 receives the purchase request command of requesting purchasing ‘5’ tickets from the first electronic terminal 10, the payment processing unit 117 may request transmission of the payment means information to the first electronic terminal 10, and when the service providing server 110 receives predetermined credit card information from the first electronic terminal 10 in response thereto, the payment processing unit 117 may calculate a price corresponding to the purchase quantity of ‘5’ tickets as ‘25000 won’ based on the purchase price information, and then perform payment processing for ‘25000 won’ based on the credit card information.

When the payment processing is completed, the profile update unit 118 generates a first transaction indicting that the first user possesses tickets of the first purchase quantity, and registers and processes the first transaction in the blockchain network 100 to process the quantity of holding tickets in the first profile table included in the first NFT registered in the blockchain network 100 to be increased by the first purchase quantity, and recorded.

In this regard, as in the above-described example, when the payment processing unit 117 completes payment processing for a price for a ticket purchase quantity of ‘5’, the profile update unit 118 generates the first transaction indicating that the first user possesses ‘5’ tickets, and registers and processes the first transaction in the blockchain network 100 to process the quantity of holding tickets in the first profile table included in the first NFT registered in the blockchain network 100 to be increased by ‘5’ which is the first purchase quantity, and recorded.

As a result, the first profile table shown in Table 2 above may be updated to Table 3 below.

TABLE 3

| Tournament | | | Information on |
|---|---|---|---|
| participation history | Level | Reward reception | quantity of |
| information | information | history information | holding tickets |
| | | | 5 |

In this case, according to an exemplary embodiment of the present disclosure, the profile update unit 118 may propagate the first transaction to the blockchain network 100 in order to register and process the first transaction in the blockchain network 100. Then, any one node of the plurality of nodes 101, 102, 103, 104, 105, and 106 constituting the blockchain network 100 may generate a block including the first transaction and propagate the generated block to the plurality of nodes 101, 102, 103, 104, 105, and 106. As a result, when the block is received in the plurality of nodes 101, 102, 103, 104, 105, and 106, the plurality of nodes 101, 102, 103, 104, 105, and 106 may record a quantity called ‘5’ as the information on the ticket holding quantity of the first user in the first profile table of the first NFT included in the blockchain data stored in each node based on the first transaction on the received block.

In such a situation, an operator of the service providing server 110 according to the present disclosure may hold a tournament competition for each of the plurality of games in order to provide the tournament game service, and in this case, the operator may open a tournament session of each of the plurality of games online in order to allow the members to participate in the tournament competition for each of the plurality of games online through electronic terminals held by the members.

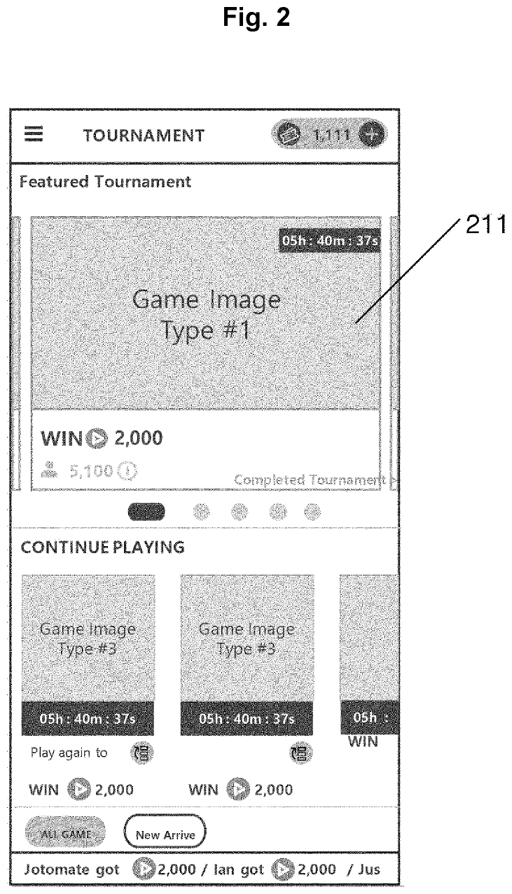

In this regard, FIG. 2 is a diagram illustrating an example of a screen in which when a specific member accesses the service providing server 110 through an electronic terminal thereof, a tournament session of each of the plurality of games is opened, which may be viewed through the electronic terminal. Here, when reference numeral 211 of FIG. 2 represents a screen in which a tournament session for a first game which is any one of the plurality of games is opened, the tournament session means a session opened so as for members who accesses the tournament session to play the first game online jointly through the electronic terminal. That is, multiple members access the tournament session through electronic terminals thereof to play the first game jointly with each other online.

As a result, the first user who completes the new user registration in the tournament game service accesses the service providing server 110 through the first electronic terminal 10 thereof to view a waiting room screen having a Ul illustrated in FIG. 2.

In this case, when the first user clicks on the tournament session for the first game represented by reference numeral 211 through the first electronic terminal 10, the first electronic terminal 10 may transmit, to the service providing server 110 of the present disclosure, an access request command to the tournament session.

In this case, according to an exemplary embodiment of the present disclosure, the service providing server 110 as a component for processing an access request command to the tournament session received from the first electronic terminal 10 may further include a confirmation unit 119 and an access permission unit 120.

When the confirmation unit 119 receives an access request command to a tournament session (the tournament session means a session opened for users accessing the tournament session through the electronic terminal to play the first game jointly online) opened for a first game which is any one of the plurality of games, from the first electronic terminal 10 after the registration processing of the first transaction in the blockchain network 100 is completed, the confirmation unit 119 requests transmission of identification information for identifying the first user, to the first electronic terminal 10, and when receiving the first user identification information from the first electronic terminal 10, the confirmation unit 119 inquires the first NFT registered in the blockchain network 100 based on the first user identification information, and confirms the quantity of holding tickets of the first user recorded in the first profile table included in the first NFT.

In this regard, as in the above-described example, when it is assumed that the first user identification information ‘1SASzdfe342sdfsdadZ09dfaawer123sdaf’ is recorded as the owner information in the first NFT, and the quantity of ‘5’ is recorded in the first profile table included in the first NFT as the information on the ticket holding quantity of the first user, the confirmation unit 119 inquires the first NFT registered in the blockchain network 100 based on the first user identification information ‘1SASzdfe342sdfsdadZ09dfaawer123sdaf’ to confirm ‘5’ which is the information on the ticket holding quantity of the first user recorded in the first profile table included in the first NFT.

The access permission unit 120 confirms a first required number which is the number of required tickets for participating in the tournament of the first game by referring to the game information storage unit 111, and when it is confirmed that the ticket holding quantity of the first user is equal to or more than the first required number, the access permission unit 120 permits the access to the tournament session of the first electronic terminal 10 to process the first electronic terminal 10 to access the tournament session.

In this regard, when it is assumed that information is stored in the game information storage unit 111 as in Table 1 above, the first game is referred to as ‘game 2’, and the quantity of holding tickets held by the first user is confirmed as ‘5’, the quantity of holding tickets held by the first user is equal to or more than ‘1’ which is the first required number for participating in the tournament for ‘game 2’, so the access permission unit 120 permits the first electronic terminal 10 to access the tournament session for ‘game 2’ to process the first electronic terminal 10 to access the tournament session.

Through this, the first user accesses the tournament session for the first game by using the first electronic terminal 10 to play the first game jointly with other users who access the tournament session in the form of the tournament online.

As such, when the access of the first electronic terminal 10 to the tournament session is permitted, the profile update unit 118 generates first tournament participation history information including date/time information at a current time and tournament information for the first game, and then generates a second traction indicating that the first tournament participation history information is new tournament participation history information for the first user, and at the same time, the first user exhausts tickets as large as the first required number, and register and process the second transaction in the blockchain network 100 to process the first tournament participation history information to be recorded in the first profile table included in the first NFT registered in the blockchain network 100, and at the same time, the quantity of holding tickets in the first profile table to be reduced and recorded by the first required number.

In this regard, as in the above-described example, when the first required number is ‘1’ as the first electronic terminal 10 accesses a tournament session for ‘game 2’, the profile update unit 118 generates first tournament participation history information including the date/time information at the current time and tournament information for ‘game 2’, and then generates a second traction indicating that the first tournament participation history information is new tournament participation history information for the first user, and at the same time, the first user exhausts tickets as large as ‘1’ which is the first required number, and register and process the second transaction in the blockchain network 100 to process the first tournament participation history information to be recorded in the first profile table included in the first NFT registered in the blockchain network 100, and at the same time, ‘5’ which is the quantity of holding tickets in the first profile table to be reduced by ‘1’ which is the first required number, and changed and recorded to ‘4’.

As a result, the first profile table shown in Table 3 above may be updated to Table 4 below.

TABLE 4

| | | Reward | |
|---|---|---|---|
| Tournament | | reception | Information on |
| participation history | Level | history | quantity of |
| information | information | information | holding tickets |
| 13:30:20 on Dec. 22, 2022 | | | 4 |
| Participation in tournament | | | |
| for ‘game 2’ | | | |

In this case, according to an exemplary embodiment of the present disclosure, the profile update unit 118 may propagate the second transaction to the blockchain network 100 in order to register and process the second transaction in the blockchain network 100. Then, any one node of a plurality of nodes 101, 102, 103, 104, 105, and 106 constituting the blockchain network 100 may generate a block including the second transaction and propagate the generated block to the plurality of nodes 101, 102, 103, 104, 105, and 106. As a result, when the block is received in the plurality of nodes 101, 102, 103, 104, 105, and 106, the plurality of nodes 101, 102, 103, 104, 105, and 106 may record the first tournament participation history information in the first profile table of the first NFT included in the blockchain data stored in each node based on the second transaction in the received block, and at the same time, change and record ‘5’ which is the information on the quantity of holding tickets of the first user to ‘4’.

In this case, according to an exemplary embodiment of the present disclosure, upon receiving the access request command to the tournament session opened for the first game from the first electronic terminal 10, the service providing server 110 performs the certification for the first user, and then only when it is confirmed that the first user is a certified member, the service providing server 110 may further include a configuration of conducting a process for determining whether to allow the first electronic terminal 10 to access the tournament session based on the ticket held by the first user.

In this regard, the completion message transmission unit 116 may include a component which stores in predetermined certification information for certifying the first user in a member database (not illustrated) afterward in the process of completing the new user registration for the first user.

In this regard, as issuance of the first NFT for the first user is completed, when the registration completion message is transmitted to the first electronic terminal 10, the completion message transmission unit 116 may request transmission of a public key for electronic signature verification and e-mail address information held by the first user, to the first electronic terminal 10.

In this case, it is assumed that a predetermined first private key for an electronic signature and a first public key corresponding thereto are pre-stored in the first electronic terminal 10. As a result, when the first electronic terminal 10 receives a transmission request of the public key and the e-mail address information from the service providing server 110 of the present disclosure, the first electronic terminal 10 may receive, from the first user, information on a first e-mail address according to an account of the first user, and then, transmit, to the service providing server 110 of the present disclosure, the first public key stored in the first electronic terminal 10, and the information on the first e-mail address received from the first user.

As such, when the service providing server 110 of the present disclosure receives the first public key corresponding to the first private key pre-stored in the first electronic terminal 10, and the information on the first e-mail address from the first electronic terminal 10, the completion message transmission unit 116 may store, in the member database, the first user identification information, and the first public key and the information on the first e-mail address to correspond to each other.

In this case, according to an exemplary embodiment of the present disclosure, the confirmation unit 119 as a component for conducting user certification may include an event generation unit 123, a certification information generation unit 124, an operating unit 125, a signature request unit 126, a certification processing unit 127, and a confirmation processing unit 128.

The event generation unit 123 generates a certification event for conducting e-mail based user certification for the first user when receiving the access request command to the tournament session opened for the first game from the first electronic terminal 10.

The certification information generation unit 124 randomly generates, when the certification event is generated, a n (n is a natural number of 2 or more)-digit first certification number, randomly generates a certification value constituted by a natural number having a size of 9 or less, and then, performs a modulo operation having the certification value as a divisor for respective digit numbers constituting the first certification number to generate an n-digit second certification number.

For example, when n is ‘3’, the certification information generation unit 124 randomly generates a 3-digit first certification number as ‘642’, randomly generates the certification value as ‘5’, and then performs a modulo operation having ‘5’ which is the certification value as the divisor for ‘‘6’, ‘4’, and ‘2’ which are respective digit numbers constituting the first certification number to generate a 3-digit second certification number as ‘142’.

The operating unit 125 generates a column vector having respective digit numbers constituting the first certification number as components and a row vector having respective digit numbers constituting the second certification number as components, and operates a matrix multiplication between the column vector and the row vector to generate an operation matrix of an n×n size, and then operates Frobenius Norm of the operation matrix. Here, Frobenius Norm means L2-Norm that represents the size of the matrix.

In this regard, as in the above-described example, when the first certification number is generated as ‘642’ and the second certification number is generated as ‘142’ through the certification information generation unit 124, the operating unit 125 generates a column vector having respective digit numbers constituting ‘642’ which is the first certification number as components as

$$‘ [ \begin{matrix}6 \\ 4 \\ 2\end{matrix} ] ’ ,$$

generates a row vector having respective digit numbers constituting ‘142’ which is the second certification number as components as ‘[1 4 2]’, and then operates the matrix multiplication between the column vector and the row vector to generate an operation matrix having a size of 3×3 as

$$‘ [ \begin{matrix}6 & 24 & 12 \\ 4 & 16 & 8 \\ 2 & 8 & 4\end{matrix} ] ’ ,$$

and operate Frobenius Norm of the operation matrix.

The signature request unit 126 requests transmission of identification information for identifying the first user to the first electronic terminal 10, and when receiving the first user identification information from the first electronic terminal 10, confirms the first e-mail address stored to correspond to the first user identification information from the member database, sends a certification e-mail including the first certification number with the first e-mail address as a receiver, and then transmits the certification value to the first electronic terminal 10, and at the same time, requests the electronic signature based on the first certification number and the certification value.

For example, as in the above-described example, when the first certification number and the certification value are set to ‘642’ and ‘5’, respectively, the signature request unit 126 may request the transmission of the identification information for identifying the first user to the first electronic terminal 10, and when receiving the first user identification information from the first electronic terminal 10, confirms the first e-mail address stored to correspond to the first user identification information from the member database, and then send a certification e-mail including ‘642’ which is the first certification number with the first e-mail address as the receiver. Then, the signature request unit 126 may transmit ‘5’ which is the certification value to the first electronic terminal 10, and at the same time, request the electronic signature based on the first certification number and the certification value.

In this case, according to an exemplary embodiment of the present disclosure, upon receiving the electronic signature request from the service providing server 110 jointly with the certification value, the first electronic terminal 10 may display a message for requesting the first user to input the first certification number included in the certification e-mail received by an account according to the first e-mail address into the first electronic terminal 10.

In this case, when the first user inputs, into the first electronic terminal 10, the first certification number included in the certification e-mail received by the account according to the first e-mail address in response to the message, the first electronic terminal 10 performs the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and operates the matrix multiplication between the column vector and the row vector to generate the operation matrix of the n×n size, and then sign the Frobenius Norm of the operation matrix with the first private key for the first user stored in the first electronic terminal 10 to generate a first electronic signature value, and transmit the generated first electronic signature value to the service providing server 110 of the present disclosure.

In this regard, as in the above-described example, when the first certification number and the certification value are ‘642’ and ‘5’, respectively, the first electronic terminal 10 may display a message for requesting the first user to input the first certification number included in the certification e-mail received by the account according to the first e-mail address into the first electronic terminal 10 when receiving the electronic signature request from the service providing server 110 jointly with ‘5’ which is the certification value.

Then, the first user logs into the account according to the first e-mail address to confirm the certification e-mail, and confirms ‘642’ which is the first certification number included in the certification e-mail to input ‘642’ which is the first certification number into the first electronic terminal 10.

As such, when the first user inputs ‘642’ which is the first certification number included in the certification e-mail into the first electronic terminal 10, the first electronic terminal 10 performs a modulo operation having ‘5’ which is the certification value as the divisor for ‘‘6’, ‘4’, and ‘2’ which are respective digit numbers constituting the first certification number to generate a 3-digit second certification number as ‘142’.

Then, the first electronic terminal 10 generates a column vector having respective digit numbers constituting ‘642’ which is the first certification number as components as

$$‘ [ \begin{matrix}6 \\ 4 \\ 2\end{matrix} ] ’$$

and generates as a row vector having respective digit numbers constituting ‘142’ which is the second certification number as components as ‘[1 4 2]’, and then operates the matrix multiplication between the column vector and the row vector to generate an operation matrix of a 3×3 size as

$$‘ [ \begin{matrix}6 & 24 & 12 \\ 4 & 16 & 8 \\ 2 & 8 & 4\end{matrix} ] ’ .$$

Thereafter, the first electronic terminal 10 operates the Frobenius Norm of the operation matrix, and then performs the electronic signature for the Frobenius Norm based on the first private key pre-stored in the first electronic terminal 10 to generate the first electronic signature value and transmit the first electronic signature value to the service providing server 110 of the present disclosure.

Upon receiving the first electronic signature value in response to the electronic signature request from the first electronic terminal 10, the certification processing unit 127 extracts the first public key stored to correspond to the first user identification information from the member database, and then compares a value acquired by decoding the first electronic signature value based on the first public key and the Frobenius Norm of the operation matrix with each other, and when it is confirmed that both values coincide with each other, completes the certification for the first user.

When the certification for the first user is completed, the confirmation processing unit 128 inquires the first NFT registered in the blockchain network 100 based on the first user identification information to confirm the ticket holding quantity of the first user recorded in the first profile table included in the first NFT.

The tournament game service according to the present disclosure may be configured to calculate, when a user who participates in a tournament for a predetermined game wins or losing the tournament, a predetermined level based on a participation record of the user. In this regard, as in the above-described example, when the level calculation criterion is designated so that the level is increased by ‘10 when winning the game by participating in a tournament for a specific game and the level is decreased by ‘5’ when losing the game, and when ‘user 1’ participates in the game, and wins 10 games and loses 5 games, the level of ‘user 1’ may be calculated as ‘75’. In such a situation, when according to a record of the user who participates in the tournament for the predetermined game, level information of the corresponding user is changed, the service providing server 110 according to the present disclosure may further include a component that updates and records matters regarding the change of the level information in the profile table on the NFT of the user.

In this regard, according to an exemplary embodiment of the present disclosure, when an event is generated, indicating which the first user completes participation in the tournament for the first game as the first electronic terminal 10 accesses the tournament session, and then the level information of the first user is changed to first level information through the tournament session as the level information of the first user is changed to and calculated as the first level information based on the participation record of the first user in the tournament the first game, the profile update unit 118 generates a third transaction indicating that the first level information is new level information for the first user, and register and processes the third transaction in the blockchain network 100 to process the first level information to be recorded in the first profile table included in the first NFT registered in the blockchain network 100.

In this regard, as in the above-described example, a situation is assumed in which the first game is ‘game 2’, and as the first electronic terminal 10 accesses the tournament session opened for ‘game 2’, the first user completes participating in the tournament for the ‘game 2’.

When a level of the first user is changed from ‘0’ to ‘10’ as the first user performs a game battle in the tournament for ‘game 2’, the service providing server 110 of the present disclosure may generate an event indicating that the level of the first user is changed from ‘0’ to ‘10’ through a tournament session opened for ‘game 2’. As such, when the event is generated, which indicates that the level of the first user is changed from ‘0’ to ‘10’ through the tournament session for ‘game 2’, the profile update unit 118 generates the third transaction indicating that the level information ‘10’ is the new level information for the first user, and registers and processes the third transaction in the blockchain network 100 to process the level information ‘10’ to be recorded in the first profile table included in the first NFT registered in the blockchain network 100.

As a result, the first profile table shown in Table 4 above may be updated to Table 5 below.

TABLE 5

| | | Reward | Information |
|---|---|---|---|
| Tournament | | reception | on quantity |
| participation history | Level | history | of holding |
| information | information | information | tickets |
| 13:30:20 on Dec. 22, 2022 | 10 | | 4 |

Participation in
tournament for ‘game 2’

In this case, according to an exemplary embodiment of the present disclosure, the profile update unit 118 may propagate the third transaction to the blockchain network 100 in order to register and process the third transaction in the blockchain network 100. Then, any one node of a plurality of nodes 101, 102, 103, 104, 105, and 106 constituting the blockchain network 100 may generate a block including the third transaction and propagate the generated block to the plurality of nodes 101, 102, 103, 104, 105, and 106. As a result, when the block is received in the plurality of nodes 101, 102, 103, 104, 105, and 106, the plurality of nodes 101, 102, 103, 104, 105, and 106 may record the level information ‘10’ in the first profile table of the first NFT included in the blockchain data stored in each node based on the third transaction on the received block.

Further, according to an exemplary embodiment of the present disclosure, the service providing server 110 may further include a configuration for paying a predetermined reward when a user who participates in a tournament for a predetermined game wins the tournament.

In this regard, the service providing server 110 according to the present disclosure may further include a reward information storage unit 121 and a reward processing unit 122.

The reward information storage unit 121 stores information on the amount of payment of cryptocurrency to be paid as a reward when winning the tournament for each of the plurality of games.

For example, the reward information storage unit 121 may store information as in Table 6 below.

TABLE 6

| Plurality of games | Payment amount of cryptocurrency |
|---|---|
| Game 1 | 5 coins |
| Game 2 | 2 coins |
| Game 3 | 13 coins |
| Game 4 | 20 coins |
| . . . | . . . |

When an event is generated, which indicates that the first user is a winner through the tournament session as the first user wins the tournament for the first game after the first user completes participating in the tournament for the first game as the first electronic terminal 10 accesses the tournament session, the reward processing unit 122 confirms a first payment amount which is the payment amount of the cryptocurrency to be paid as the reward when winning the tournament for the first game by referring to the reward information storage unit 121, and receives information on a wallet address of the first user for accumulating the cryptocurrency from the first electronic terminal 10, and then transfers the cryptocurrency of the first payment amount to the wallet address of the first user to complete the reward processing for the first user.

In this regard, as in the above-described example, a situation is assumed in which the first game is ‘game 2’, and as the first electronic terminal 10 accesses the tournament session opened for ‘game 2’, the first user completes participating in the tournament for the ‘game 2’.

When the first user wins the tournament for ‘game 2’, the service providing server 110 of the present disclosure may generate an event indicating that the first user is the winner through the tournament session opened for ‘game 2’. As such, when the event indicating that the first user is the winner is generated through the tournament session for ‘game 2’, the reward processing unit 122 may confirm that the payment amount of the cryptocurrency to be paid as the reward when winning the tournament for ‘game 2’ is ‘2 coins’ by referring to the reward information storage unit 121.

Then, the reward processing unit 122 requests the first electronic terminal 10 to transmit the information on the wallet address of the first user for accumulating the cryptocurrency, and then when receiving the information on the wallet address of the first user from the first electronic terminal 10, transfers the cryptocurrency of ‘2 coins’ to the wallet address of the first user to complete the reward processing for the first user.

Through this, when the members who subscribes to and registers in the tournament game service of the present disclosure win the tournaments for the games participated thereby, the members may receive the rewards thereof as the cryptocurrency, and will be able to more actively participate in the tournaments for the games due to the reward.

As such, when the reward processing for the first user is completed, the profile update unit 118 generates first reward reception history information including the date/time information at the current time, and information on the first payment amount, and then generates a fourth transaction indicating that the first reward reception history information is new reward reception history information for the first user, and registers and processes the fourth transaction in the blockchain network 100 to process the first reward reception history information to be recorded in the first profile table included in the first NFT registered in the blockchain network 100.

In this regard, as in the above-described example, when payment of cryptocurrency of ‘2 coins’ as the reward for the first user is completed, the profile update unit 118 generates first reward reception history information including the date/time information at the current time, and information on ‘2 coins’ which is the first payment amount, and then generates a fourth transaction indicating that the first reward reception history information is new reward reception history information for the first user, and registers and processes the fourth transaction in the blockchain network 100 to process the first reward reception history information to be recorded in the first profile table included in the first NFT registered in the blockchain network 100.

As a result, the first profile table shown in Table 5 above may be updated to Table 7 below.

TABLE 7

| | | | Information |
|---|---|---|---|
| | | | on quantity |
| Tournament participation | Level | Reward reception history | of holding |
| history information | information | information | tickets |
| 13:30:20 on Dec. 22, | 10 | 15:30 on Dec. 23, 2022 | 4 |
| 2022 | | ‘2 coins’ are paid as reward by | |
| Participation in tournament | | winning tournament for ‘game 2’ | |
| for ‘game 2’ | | | |

In this case, according to an exemplary embodiment of the present disclosure, the profile update unit 118 may propagate the fourth transaction to the blockchain network 100 in order to register and process the fourth transaction in the blockchain network 100. Then, any one node of a plurality of nodes 101, 102, 103, 104, 105, and 106 constituting the blockchain network 100 may generate a block including the fourth transaction and propagate the generated block to the plurality of nodes 101, 102, 103, 104, 105, and 106. As a result, when the block is received in the plurality of nodes 101, 102, 103, 104, 105, and 106, the plurality of nodes 101, 102, 103, 104, 105, and 106 may record the first reward reception history information in the first profile table of the first NFT included in the blockchain data stored in each node based on the fourth transaction on the received block.

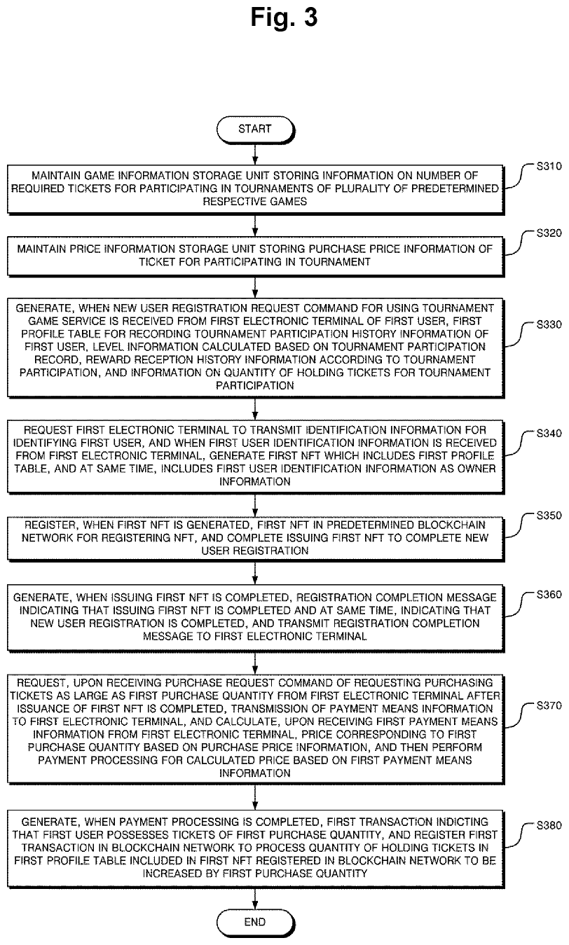

FIG. 3 is a flowchart illustrating an operating method of a service providing server that provides a tournament game service that supports participation in a game tournament through the setting of a non-fungible token (NFT)-based user profile according to an exemplary embodiment of the present disclosure.

In step S310, a game information storage unit is maintained, which stores information on the number of required tickets for participating in tournaments of a plurality of predetermined respective games.

In step S320, a price information storage unit is maintained, which stores purchase price information of the ticket for participating in the tournament.

In step S330, when a new user registration request command for using the tournament game service is received from a first electronic terminal of a first user, a first profile table for recording tournament participation history information of the first user, level information calculated based on a tournament participation record, reward reception history information according to tournament participation, and information on the quantity of holding tickets for the tournament participation is generated.

In step S340, the first electronic terminal is requested to transmit identification information for identifying the first user, and when first user identification information is received from the first electronic terminal, a first NFT is generated which includes the first profile table, and at the same time, includes the first user identification information as owner information.

In step S350, when the first NFT is generated, the first NFT is registered and processed in a predetermined blockchain network for registering the NFT, and issuing the first NFT is completed to complete new user registration.

In step S360, when issuance of the first NFT is completed, a registration completion message indicating that issuance of the first NFT is completed and at the same time, indicating that the new user registration is completed is generated, and transmitted to the first electronic terminal.

In step S370, upon receiving the purchase request command of requesting purchasing tickets as large as a first purchase quantity from the first electronic terminal after the issuance of the first NFT is completed, transmission of payment means information is requested to the first electronic terminal, and upon receiving first payment means information from the first electronic terminal, a price corresponding to the first purchase quantity is calculated based on the purchase price information, and then payment processing for the calculated price is performed based on the first payment means information.

In step S380, when the payment processing is completed, a first transaction indicting that the first user possesses tickets of the first purchase quantity is generated, and the first transaction is registered and processed in the blockchain network to process the quantity of holding tickets in the first profile table included in the first NFT registered in the blockchain network to be increased by the first purchase quantity, and recorded.

In this case, according to an exemplary embodiment of the present disclosure, the operating method of the service providing server may further include a step of requesting, when receiving an access request command to a tournament session (the tournament session means a session opened for users accessing the tournament session through the electronic terminal to play the first game jointly online) opened for a first game which is any one of the plurality of games from the first electronic terminal after the registration processing of the first transaction in the blockchain network is completed, transmission of identification information for identifying the first user, to the first electronic terminal, and when receiving the first user identification information from the first electronic terminal, inquiring the first NFT registered in the blockchain network based on the first user identification information, and confirming the quantity of holding tickets of the first user recorded in the first profile table included in the first NFT, a step of confirming a first required number which is the number of required tickets for participating in the tournament of the first game by referring to the game information storage unit, and when it is confirmed that the quantity of holding tickets of the first user is equal to or more than the first required number, permitting the first electronic terminal to access the tournament session to process the first electronic terminal to access the tournament session, and a step of generating, when the access of the first electronic terminal to the tournament session is permitted, first tournament participation history information including date/time information at a current time and tournament information for the first game, and then generating a second traction indicating that the first tournament participation history information is new tournament participation history information for the first user, and at the same time, the first user exhausts tickets as large as the first required number, and registering and processing the second transaction in the blockchain network to process the first tournament participation history information to be recorded in the first profile table included in the first NFT registered in the blockchain network, and at the same time, the quantity of holding tickets in the first profile table to be reduced and recorded by the first required number.

In this case, according to an exemplary embodiment of the present disclosure, the operating method of the service providing server may further include a step of generating, when an event is generated, which indicates that the first user completes participation in the tournament for the first game as the first electronic terminal accesses the tournament session, and then the level information of the first user is changed to first level information through the tournament session as the level information of the first user is changed to and calculated as the first level information based on the participation record of the first user in the tournament the first game, a third transaction indicating that the first level information is new level information for the first user, and registering and processing the third transaction in the blockchain network to process the first level information to be recorded in the first profile table included in the first NFT registered in the blockchain network.

Further, according to an exemplary embodiment of the present disclosure, the operating method of the service providing server may further include a step of maintaining a reward information storage unit storing information on the amount of payment of cryptocurrency to be paid as a reward when winning the tournament for each of the plurality of games, a step of confirming, when an event occurs, which indicates that the first user is a winner through the tournament session as the first user wins the tournament for the first game after the first user completes participating in the tournament for the first game as the first electronic terminal accesses the tournament session, a first payment amount which is the payment amount of the cryptocurrency to be paid as the reward when winning the tournament for the first game by referring to the reward information storage unit, and a step of receiving information on a wallet address of the first user for accumulating the cryptocurrency from the first electronic terminal, and then transferring the cryptocurrency of the first payment amount to the wallet address of the first user to complete reward processing for the first user, and a step of generating, when the reward processing for the first user is completed, first reward reception history information including the date/time information at the current time, and information on the first payment amount, and then generating a fourth transaction indicating that the first reward reception history information is new reward reception history information for the first user, and registering and processing the fourth transaction in the blockchain network to process the first reward reception history information to be recorded in the first profile table included in the first NFT registered in the blockchain network.

Further, according to an exemplary embodiment of the present disclosure, in step S360, when the registration completion message is transmitted to the first electronic terminal, transmission of a public key for electronic signature verification and e-mail address information held by the first user may be requested to the first electronic terminal, and when the first public key corresponding to the first private key pre-stored in the first electronic terminal, and the information on the first e-mail address are received from the first electronic terminal, the first user identification information, and the first public key and the information on the first e-mail address may be stored in the member database to correspond to each other.

In this case, the confirming may include generating a certification event for conducting e-mail based user certification for the first user when receiving the access request command to the tournament session opened for the first game from the first electronic terminal, randomly generating, when the certification event is generated, an n (n is a natural number of 2 or more)-digit first certification number, randomly generating a certification value constituted by a natural number having a size of 9 or less, and then, performing a modulo operation having the certification value as a divisor for respective digit numbers constituting the first certification number to generate an n-digit second certification number, generating a column vector having respective digit numbers constituting the first certification number as components and a row vector having respective digit numbers constituting the second certification number as components, and operating a matrix multiplication between the column vector and the row vector to generate an operation matrix of an n×n size, and then operating Frobenius Norm of the operation matrix, requesting transmission of identification information for identifying the first user to the first electronic terminal, and when receiving the first user identification information from the first electronic terminal, confirming the first e-mail address stored to correspond to the first user identification information from the member database, sending a certification e-mail including the first certification number with the first e-mail address as a receiver, and then transmitting the certification value to the first electronic terminal, and at the same time, requesting the electronic signature based on the first certification number and the certification value, when receiving a first electronic signature value (the first electronic signature value is generated by performing, when the certification value is received in the first electronic terminal, and the first user inputs the first certification number included in the certification e-mail received by an account according to the first e-mail address into the first electronic terminal, by the first electronic terminal, the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and operating the matrix multiplication between the column vector and the row vector to generate the operation matrix of the n×n size, and then signing the Frobenius Norm of the operation matrix with the first private key stored in the first electronic terminal) from the first electronic terminal in response to the electronic signature request, extracting the first public key stored to correspond to the first user identification information from the member database, and then comparing a value acquired by decoding the first electronic signature value based on the first public key and the Frobenius Norm of the operation matrix with each other, and when it is confirmed that both values coincide with each other, completing the certification for the first user, and when the certification for the first user is completed, inquiring the first NFT registered in the blockchain network based on the first user identification information to confirm a ticket holding quantity of the first user recorded in the first profile table included in the first NFT.

Hereinabove, referring to FIG. 3, the operating method of the service providing server according to an exemplary embodiment of the present disclosure is described. Here, since the operating method of the service providing server according to an exemplary embodiment of the present disclosure may correspond to the configuration of the operation of the service providing server 110 described by using FIGS. 1 and 2, a more detailed description thereof will be omitted.

The operating method of the service providing server according to an exemplary embodiment of the present disclosure may be implemented by a computer program stored in a storage medium for executing the computer program through combination with a computer.

Further, The operating method of the service providing server according to an exemplary embodiment of the present disclosure may be implemented in a program command type which may be performed through various computer means and recorded in a computer readable medium. The computer readable medium may include a program command, a data file, a data structure, etc., singly or combinationally. The program command recorded in the medium may be specially designed and configured for the present disclosure, or may be publicly known to and used by those skilled in the computer software field. An example of the computer readable recording medium includes magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program command. An example of the program command includes a high-level language code executable by a computer by using an interpreter and the like, as well as a machine language code created by a compiler.

As described above, the present disclosure has been described by specified matters such as detailed components, and the like and limited exemplary embodiments and drawings, but the description is just provided to assist more overall understanding of the present disclosure and the present disclosure is not limited to the exemplary embodiment and various modifications and changes can be made by those skilled in the art from such a disclosure.

Accordingly, the spirit of the present disclosure should not be defined only by the described exemplary embodiments, and it should be appreciated that claims to be described below and all things which are equivalent to the claims or equivalently modified to the claims are included in the scope of the spirit of the present disclosure.

What is claimed is:

1. A service providing server that provides a tournament game service that supports participation in a game tournament through the setting of an NFT-based user profile, comprising:
a game information storage unit storing information on the number of required tickets for participating in tournaments of a plurality of predetermined respective games;
a price information storage unit storing purchase price information of the ticket for participating in the tournament;
a profile generation unit generating, when a new user registration request command for using the tournament game service is received from a first electronic terminal of a first user, a first profile table for recording tournament participation history information of the first user, level information calculated based on a tournament participation record, reward reception history information according to tournament participation, and information on the quantity of holding tickets for the tournament participation;
an NFT generation unit requesting the first electronic terminal to transmit identification information for identifying the first user, and when first user identification information is received from the first electronic terminal, generating a first NFT which includes the first profile table, and at the same time, includes the first user identification information as owner information;
a registration processing unit registering, when the first NFT is generated, the first NFT in a predetermined blockchain network for registering the NFT, and completing issuing the first NFT to complete new user registration;
a completion message transmission unit generating, when issuance of the first NFT is completed, a registration completion message indicating that issuance of the first NFT is completed and at the same time, indicating that the new user registration is completed, and transmitting the registration completion message to the first electronic terminal;
a payment processing unit requesting, upon receiving the purchase request command of requesting purchasing tickets as large as a first purchase quantity from the first electronic terminal after the issuance of the first NFT is completed, transmission of payment means information to the first electronic terminal, and calculating, upon receiving first payment means information from the first electronic terminal, a price corresponding to the first purchase quantity based on the purchase price information, and then performing payment processing for the calculated price based on the first payment means information; and
a profile update unit generating, when the payment processing is completed, a first transaction indicting that the first user possesses tickets of the first purchase quantity, and registering the first transaction in the blockchain network to process the quantity of holding tickets in the first profile table included in the first NFT registered in the blockchain network to be increased by the first purchase quantity.

2. The service providing server of claim 1, further comprising:
a confirmation unit requesting, when receiving an access request command to a tournament session, wherein the tournament session means a session opened for users accessing the tournament session through the electronic terminal to play the first game jointly online, opened for a first game which is any one of the plurality of games, from the first electronic terminal after the registration processing of the first transaction in the blockchain network is completed, transmission of identification information for identifying the first user, to the first electronic terminal, and when receiving the first user identification information from the first electronic terminal, inquiring the first NFT registered in the blockchain network based on the first user identification information, and confirming a ticket holding quantity of the first user recorded in the first profile table included in the first NFT; and
an access permission unit confirming a first required number which is the number of required tickets for participating in the tournament of the first game by referring to the game information storage unit, and when it is confirmed that the ticket holding quantity of the first user is equal to or more than the first required number, permitting the access to the tournament session of the first electronic terminal to process the first electronic terminal to access the tournament session,
wherein when the access of the first electronic terminal to the tournament session is permitted, the profile update unit generates first tournament participation history information including date/time information at a current time and tournament information for the first game, and then generates a second transaction indicating that the first tournament participation history information is new tournament participation history information for the first user, and at the same time, the first user exhausts tickets as large as the first required number, and registers the second transaction in the blockchain network to process the first tournament participation history information to be recorded in the first profile table included in the first NFT registered in the blockchain network, and at the same time, the quantity of holding tickets in the first profile table to be reduced by the first required number.

3. The service providing server of claim 2, wherein the profile update unit generates, when an event is generated, which indicates that the first user completes participation in the tournament for the first game as the first electronic terminal accesses the tournament session, and then the level information of the first user is changed to first level information through the tournament session as the level information of the first user is changed to and calculated as the first level information based on the participation record of the first user in the tournament for the first game, a third transaction indicating that the first level information is new level information for the first user, and registers the third transaction in the blockchain network to process the first level information to be recorded in the first profile table included in the first NFT registered in the blockchain network.

4. The service providing server of claim 2, further comprising:
a reward information storage unit storing information on the amount of payment of cryptocurrency to be paid as a reward when winning the tournament for each of the plurality of games; and
a reward processing unit confirming, when an event occurs, which indicates that the first user is a winner through the tournament session as the first user wins the tournament for the first game after the first user completes participating in the tournament for the first game as the first electronic terminal accesses the tournament session, a first payment amount which is the payment amount of the cryptocurrency to be paid as the reward when winning the tournament for the first game by referring to the reward information storage unit, and receiving information on a wallet address of the first user for accumulating the cryptocurrency from the first electronic terminal, and then transferring the cryptocurrency of the first payment amount to the wallet address of the first user to complete the reward processing for the first user,
wherein when the reward processing for the first user is completed, the profile update unit generates first reward reception history information including the date/time information at the current time, and information on the first payment amount, and then generates a fourth transaction indicating that the first reward reception history information is new reward reception history information for the first user, and registers the fourth transaction in the blockchain network to process the first reward reception history information to be recorded in the first profile table included in the first NFT registered in the blockchain network.

5. The service providing server of claim 2, wherein when the registration completion message is transmitted to the first electronic terminal, the completion message transmission unit requests transmission of a public key for electronic signature verification and e-mail address information held by the first user to the first electronic terminal, and when the first public key corresponding to the first private key pre-stored in the first electronic terminal, and the information on the first e-mail address are received from the first electronic terminal, stores the first user identification information, and the first public key and the information on the first e-mail address in the member database to correspond to each other, and
the confirmation unit includes
an event generation unit generating a certification event for conducting e-mail based user certification for the first user when receiving the access request command to the tournament session opened for the first game from the first electronic terminal,
a certification information generation unit randomly generating, when the certification event is generated, a n, wherein n is a natural number of 2 or more, digit first certification number, randomly generating a certification value constituted by a natural number having a size of 9 or less, and then, performing a modulo operation having the certification value as a divisor for respective digit numbers constituting the first certification number to generate an n-digit second certification number,
an operating unit generating a column vector having respective digit numbers constituting the first certification number as components and a row vector having respective digit numbers constituting the second certification number as components, and operating a matrix multiplication between the column vector and the row vector to generate an operation matrix of an n×n size, and then operating Frobenius Norm of the operation matrix,
a signature request unit requesting transmission of identification information for identifying the first user to the first electronic terminal, and when receiving the first user identification information from the first electronic terminal, confirming the first e-mail address stored to correspond to the first user identification information from the member database, sending a certification e-mail including the first certification number with the first e-mail address as a receiver, and then transmitting the certification value to the first electronic terminal, and at the same time, requesting the electronic signature based on the first certification number and the certification value,
a certification processing unit extracting, when receiving a first electronic signature value, wherein the first electronic signature value is generated by performing, when the certification value is received in the first electronic terminal, and the first user inputs the first certification number included in the certification e-mail received by an account according to the first e-mail address into the first electronic terminal, by the first electronic terminal, the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and operating the matrix multiplication between the column vector and the row vector to generate the operation matrix of the n×n size, and then signing the Frobenius Norm of the operation matrix with the first private key stored in the first electronic terminal, from the first electronic terminal in response to the electronic signature request, the first public key stored to correspond to the first user identification information from the member database, and then comparing a value acquired by decoding the first electronic signature value based on the first public key and the Frobenius Norm of the operation matrix with each other, and when it is confirmed that both values coincide with each other, completing the certification for the first user, and
a confirmation processing unit inquiring, when the certification for the first user is completed, the first NFT registered in the blockchain network based on the first user identification information to confirm the ticket holding quantity of the first user recorded in the first profile table included in the first NFT.

6. An operating method of a service providing server that provides a tournament game service that supports participation in a game tournament through the setting of an NFT-based user profile, comprising:
maintaining a game information storage unit storing information on the number of required tickets for participating in tournaments of a plurality of predetermined respective games;
maintaining a price information storage unit storing purchase price information of the ticket for participating in the tournament;
generating, when a new user registration request command for using the tournament game service is received from a first electronic terminal of a first user, a first profile table for recording tournament participation history information of the first user, level information calculated based on a tournament participation record, reward reception history information according to tournament participation, and information on the quantity of holding tickets for the tournament participation;
requesting the first electronic terminal to transmit identification information for identifying the first user, and when first user identification information is received from the first electronic terminal, generating a first NFT which includes the first profile table, and at the same time, includes the first user identification information as owner information;
registering, when the first NFT is generated, the first NFT in a predetermined blockchain network for registering the NFT, and completing issuing the first NFT to complete new user registration;
generating, when issuance of the first NFT is completed, a registration completion message indicating that issuance of the first NFT is completed and at the same time, indicating that the new user registration is completed, and transmitting the registration completion message to the first electronic terminal;
requesting, upon receiving the purchase request command of requesting purchasing tickets as large as a first purchase quantity from the first electronic terminal after the issuance of the first NFT is completed, transmission of payment means information to the first electronic terminal, and calculating, upon receiving first payment means information from the first electronic terminal, a price corresponding to the first purchase quantity based on the purchase price information, and then performing payment processing for the calculated price based on the first payment means information; and
generating, when the payment processing is completed, a first transaction indicting that the first user possesses tickets of the first purchase quantity, and registering the first transaction in the blockchain network to process the quantity of holding tickets in the first profile table included in the first NFT registered in the blockchain network to be increased by the first purchase quantity.

7. The operating method of claim 6, further comprising:
requesting, when receiving an access request command to a tournament session, wherein the tournament session means a session opened for users accessing the tournament session through the electronic terminal to play the first game jointly online, opened for a first game which is any one of the plurality of games, from the first electronic terminal after the registration processing of the first transaction in the blockchain network is completed, transmission of identification information for identifying the first user, to the first electronic terminal, and when receiving the first user identification information from the first electronic terminal, inquiring the first NFT registered in the blockchain network based on the first user identification information, and confirming a ticket holding quantity of the first user recorded in the first profile table included in the first NFT;
confirming a first required number which is the number of required tickets for participating in the tournament of the first game by referring to the game information storage unit, and when it is confirmed that the ticket holding quantity of the first user is equal to or more than the first required number, permitting the access to the tournament session of the first electronic terminal to process the first electronic terminal to access the tournament session; and
when the access of the first electronic terminal to the tournament session is permitted, generating first tournament participation history information including date/time information at a current time and tournament information for the first game, and then generating a second transaction indicating that the first tournament participation history information is new tournament participation history information for the first user, and at the same time, the first user exhausts tickets as large as the first required number, and registering the second transaction in the blockchain network to process the first tournament participation history information to be recorded in the first profile table included in the first NFT registered in the blockchain network, and at the same time, the quantity of holding tickets in the first profile table to be reduced by the first required number.

8. The operating method of claim 7, further comprising:
generating, when an event is generated, which indicates that the first user completes participation in the tournament for the first game as the first electronic terminal accesses the tournament session, and then the level information of the first user is changed to first level information through the tournament session as the level information of the first user is changed to and calculated as the first level information based on the participation record of the first user in the tournament the first game, a third transaction indicating that the first level information is new level information for the first user, and registering the third transaction in the blockchain network to process the first level information to be recorded in the first profile table included in the first NFT registered in the blockchain network.

9. The operating method of claim 7, further comprising:
maintaining a reward information storage unit storing information on the amount of payment of cryptocurrency to be paid as a reward when winning the tournament for each of the plurality of games;
confirming, when an event occurs, which indicates that the first user is a winner through the tournament session as the first user wins the tournament for the first game after the first user completes participating in the tournament for the first game as the first electronic terminal accesses the tournament session, a first payment amount which is the payment amount of the cryptocurrency to be paid as the reward when winning the tournament for the first game by referring to the reward information storage unit, and receiving information on a wallet address of the first user for accumulating the cryptocurrency from the first electronic terminal, and then transferring the cryptocurrency of the first payment amount to the wallet address of the first user to complete the reward processing for the first user; and
when the reward processing for the first user is completed, generating first reward reception history information including the date/time information at the current time, and information on the first payment amount, and then generating a fourth transaction indicating that the first reward reception history information is new reward reception history information for the first user, and registering the fourth transaction in the blockchain network to process the first reward reception history information to be recorded in the first profile table included in the first NFT registered in the blockchain network.

10. The operating method of claim 7, wherein in the transmitting the registration completion message to the first electronic terminal, when the registration completion message is transmitted to the first electronic terminal, transmission of a public key for electronic signature verification and e-mail address information held by the first user is requested to the first electronic terminal, and when the first public key corresponding to the first private key pre-stored in the first electronic terminal, and the information on the first e-mail address are received from the first electronic terminal, the first user identification information, and the first public key and the information on the first e-mail address are stored in the member database to correspond to each other, and
the confirming includes
generating a certification event for conducting e-mail based user certification for the first user when receiving the access request command to the tournament session opened for the first game from the first electronic terminal,
randomly generating, when the certification event is generated, a n, wherein n is a natural number of 2 or more, digit first certification number, randomly generating a certification value constituted by a natural number having a size of 9 or less, and then, performing a modulo operation having the certification value as a divisor for respective digit numbers constituting the first certification number to generate an n-digit second certification number,
generating a column vector having respective digit numbers constituting the first certification number as components and a row vector having respective digit numbers constituting the second certification number as components, and operating a matrix multiplication between the column vector and the row vector to generate an operation matrix of an n×n size, and then operating Frobenius Norm of the operation matrix,
requesting transmission of identification information for identifying the first user to the first electronic terminal, and when receiving the first user identification information from the first electronic terminal, confirming the first e-mail address stored to correspond to the first user identification information from the member database, sending a certification e-mail including the first certification number with the first e-mail address as a receiver, and then transmitting the certification value to the first electronic terminal, and at the same time, requesting the electronic signature based on the first certification number and the certification value,
extracting, when receiving a first electronic signature value, wherein the first electronic signature value is generated by performing, when the certification value is received in the first electronic terminal, and the first user inputs the first certification number included in the certification e-mail received by an account according to the first e-mail address into the first electronic terminal, by the first electronic terminal, the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and operating the matrix multiplication between the column vector and the row vector to generate the operation matrix of the n×n size, and then signing the Frobenius Norm of the operation matrix with the first private key stored in the first electronic terminal, from the first electronic terminal in response to the electronic signature request, the first public key stored to correspond to the first user identification information from the member database, and then comparing a value acquired by decoding the first electronic signature value based on the first public key and the Frobenius Norm of the operation matrix with each other, and when it is confirmed that both values coincide with each other, completing the certification for the first user, and
inquiring, when the certification for the first user is completed, the first NFT registered in the blockchain network based on the first user identification information to confirm the ticket holding quantity of the first user recorded in the first profile table included in the first NFT.

11. A non-transitory computer readable recording medium having a program recorded therein for allowing a computer to execute an operating method of a service providing server that provides a tournament game service that supports participation in a game tournament through the setting of an NFT-based user profile, comprising:
maintaining a game information storage unit storing information on the number of required tickets for participating in tournaments of a plurality of predetermined respective games;
maintaining a price information storage unit storing purchase price information of the ticket for participating in the tournament;
generating, when a new user registration request command for using the tournament game service is received from a first electronic terminal of a first user, a first profile table for recording tournament participation history information of the first user, level information calculated based on a tournament participation record, reward reception history information according to tournament participation, and information on the quantity of holding tickets for the tournament participation;
requesting the first electronic terminal to transmit identification information for identifying the first user, and when first user identification information is received from the first electronic terminal, generating a first NFT which includes the first profile table, and at the same time, includes the first user identification information as owner information;
registering, when the first NFT is generated, the first NFT in a predetermined blockchain network for registering the NFT, and completing issuing the first NFT to complete new user registration;
generating, when issuance of the first NFT is completed, a registration completion message indicating that issuance of the first NFT is completed and at the same time, indicating that the new user registration is completed, and transmitting the registration completion message to the first electronic terminal;
requesting, upon receiving the purchase request command of requesting purchasing tickets as large as a first purchase quantity from the first electronic terminal after the issuance of the first NFT is completed, transmission of payment means information to the first electronic terminal, and calculating, upon receiving first payment means information from the first electronic terminal, a price corresponding to the first purchase quantity based on the purchase price information, and then performing payment processing for the calculated price based on the first payment means information; and
generating, when the payment processing is completed, a first transaction indicting that the first user possesses tickets of the first purchase quantity, and registering the first transaction in the blockchain network to process the quantity of holding tickets in the first profile table included in the first NFT registered in the blockchain network to be increased by the first purchase quantity.
